(19) United States
(12) Patent Application Publication
(10) Pub. No.: US 2020/0260657 A1
(43) Pub. Date: Aug. 20, 2020

(54) BIODEGRADABLE CONTAINERS WITH SEEDS

(71) Applicants: Dante Latessa, Boston, MA (US); Edward Latessa, Boston, MA (US)

(72) Inventors: Dante Latessa, Boston, MA (US); Edward Latessa, Boston, MA (US)

(21) Appl. No.: 16/794,584

(22) Filed: Feb. 19, 2020

Related U.S. Application Data
(60) Provisional application No. 62/807,288, filed on Feb. 19, 2019.

(51) Int. Cl. A01G 9/029; B65D 65/46

(52) U.S. Cl. CPC A01G 9/0293; A01G 9/0291; B65D 65/466

(57) ABSTRACT

Apparatus is provided for biodegradable containers with seeds that can be germinated, wherein the seeds are included in or enclosed in the material of the biodegradable container, or wherein the seeds are included in or enclosed in a biodegradable element of a container. The apparatus presented comprises a container disposed to contain its primary contents. The container may be biodegradable, or may comprise an element which is biodegradable, whether or not the remainder of the container is biodegradable. The container, and/or the element of the container, is disposed to include or enclose one or more seeds, providing a container or element which may be planted and grow a plant, and not placed into the waste stream. The present invention solves problems with the currently available means and apparatuses of containers, biodegrading, and management of the waste stream.

### FIELD OF THE INVENTION

The presently disclosed subject matter relates to providing apparatus for biodegradable containers, and more particularly, to apparatus for biodegradable containers with seeds that can germinated, wherein the seeds are included in or enclosed in the material of the biodegradable container, or wherein the seeds are included in or enclosed in a biodegradable element of a container.

### BACKGROUND OF THE INVENTION

Containers are used in almost every aspect of economic activity, for everything from pharmaceuticals to food and beverage packaging. Even where containers are recyclable or biodegradable, or both, the costs of transportation and processing are not insignificant, and the waste stream—meaning the effective supply chain of garbage and recycling materials generated by people—is voluminous, and expensive to manage and process. Containers, or elements of containers, could be put to other uses. One possibility is to include or enclose seeds in the material of a container or in an element of a container, so that the biodegradable material of that element of a container could be planted and used to grow one or more plants.

### SUMMARY OF THE INVENTION

The present invention meets all these needs, by disclosing apparatus that comprise biodegradable containers or biodegradable elements of containers, which can contain one or more seeds for germination and growth of a plant or plants. The present invention further addresses the problems of other attempts at making biodegradable containers which included seeds.

Further, the present invention introduces a product that allows seeds to be included in the biodegradable container, in one or more separate compartments inside the container. The container also contains its contents, in the main space of the container, and the seeds may be in a separate compartment or section of the container. In another aspect of the present invention, the seeds may be included in or enclosed in the material of the container, so that the container does not need a separate compartment to include or enclose the seeds so as to keep them secure and separate from the other (primary) contents of the container.

These aspects of the present invention, and others disclosed in the Detailed Description of the Drawings, represent improvements on the current art. This summary is provided to introduce a selection of concepts in a simplified form that are further described below in the Detailed Description of the Drawings. This Summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of various embodiments, is better understood when read in conjunction with the appended drawings. For the purposes of illustration, the drawings show exemplary embodiments; but the presently disclosed subject matter is not limited to the specific methods and instrumentalities disclosed. In the drawings, like reference characters generally refer to the same components or steps of the device throughout the different figures. In the following detailed description, various embodiments of the present invention are described with reference to the following drawings, in which:

FIG. 1 shows a front and top perspective view of an aspect of the apparatus of the present invention.

FIG. 2 shows a front elevation view of an aspect of the apparatus of the present invention.

FIG. 3 shows a front and top perspective view of an aspect of the apparatus of the present invention.

FIG. 4 shows a cross-section view of an aspect of the apparatus of the present invention.

### DETAILED DESCRIPTION OF THE DRAWINGS

The presently disclosed invention is described with specificity to meet statutory requirements. But, the description itself is not intended to limit the scope of this patent. Rather, the claimed invention might also be embodied in other ways, to include different steps or elements similar to the ones described in this document, in conjunction with other present or future technologies. Moreover, although the term “step” or similar terms may be used herein to connote different aspects of methods employed, the term should not be interpreted as implying any particular order among or between various steps herein disclosed unless and except when the order of individual steps is explicitly described.

In the following description, numerous specific details are set forth to provide a thorough understanding of the invention. But, the present invention may be practiced without these specific details. Structures and techniques that would be known to one of ordinary skill in the art have not been shown in detail, in order not to obscure the invention. Referring to the figures, it is possible to see the various major elements constituting the apparatus and methods of use the present invention.

Most consumer plastics labeled as biodegradable take 6 months or more to break down and often require specialized treatment, e.g., composting. The present disclosure includes a method to create rapidly and easily biodegradable material to be utilized in consumer plastics, with particular attention to the production of an environmentally friendly and health promoting pill bottle.

With this disclosure, we have created a pill bottle and other consumer packaging that can biodegrade within 2-4 weeks by simply throwing the discarded item outside, e.g., in the grass or planted in soil. The product, essentially made from vegetation or food from the outset, returns to its natural state.

As outlined below, the method involves a two-phase process: (1) Obtaining and chemically converting leftover food/organic waste or other food products into a solution suitable for fabrication and (2) Using a nanofiber fabrication technique called rotary jet spinning (RJS) and/or 3D printing to mold the organic solution into the desired packaging shape.

Phase 1

We start by obtaining food/organic waste or other food products (i.e., the material starts from pure food-based vegetation), including fruits and vegetables and fruit and vegetable waste or byproducts such as skins. Examples include grape skin, apple peel, apple core, orange rind/peel, banana peel, and sugar cane, among others. Other source material may include algae and chitosan (cellulose derived from chitin shells of shrimp and other crustaceans).

We then apply a chemical process to the initial organic product to convert it into a solution suitable for the remainder of the fabrication process. These chemical reactions vary slightly based on the starting product and have been described elsewhere. The solution is also sterilized at this stage (e.g., via autoclave, boiling, or similar standard process) to remove any bacteria or unwanted contaminants.

As one example of this process:

We will turn banana skin into a liquid cellulose derivative via a modified method based on Adinugraha et al (Synthesis and characterization of sodium carboxymethylcellulose from cavendish banana pseudo stem (Musa cavendishii LAMBERT), Carbohydrate Polymers. 2005. 62(2): 164-169)).

### Another Example

We will turn apples, apple skins, and apple cores into a liquid pectin as follows: Add apple products to container with water and lemon juice and bring to a boil for 1 hour. Strain remaining product with cheesecloth and allow to cool.

### Another Example

We will turn grape skins into a liquid cellulose polysaccharide derivative via a modified method based on Lu et al (Cellulose isolation and core-shell nanostructures of cellulose nanocrystals from chardonnay grape skins, Carbohydrate Polymers. 2012. 87(4): 2546-2553).

Phase 2

The organic solution in liquid form is then transferred to the fabrication process, which relies on a combination of rotary jet spinning (RJS) and/or 3D printing as outlined below.

Option A

3D printing can be used to create a mold for RJS. Organic solution from Phase 1 above is placed in the rotary jet spinner, which creates a hardened nanofiber mesh/matrix around the mold provided, based on currently available commercially available devices and methods.

Option B

Organic solution from Phase 1 is applied directly as 3D printer liquid resin or as part of a 3D printer filament, which is then programmed to print out the mold directly in the hardened biodegradable material.

Because the end products are simply food and vegetation-based products, they will decay and biodegrade quickly and naturally with direct exposure to outdoor elements, e.g., soil, water, sun, etc. The product will not decay until it hits soil and/or water.

Our initial use case will be to create an environmentally friendly and health promoting pill bottle (i.e., the mold described above will be in the shape of a standard pill bottle and pill bottle cap). The product created in Phase 2 will have plant and/or flower seeds added either directly to the pre-Phase 2 production mixture or affixed to the post-Phase 2 product. Upon biodegradation of the product, the seeds will be able to grow. Our vision is for an individual to be able to complete a medication prescription, discard their biodegradable pill bottle in their backyard or a potted plant, and have a new plant growth within 4 weeks. This cycle will be healing for both the individual and the environment and solves a major problem of excessive pill bottle waste.

Beyond this use case, we believe our product will also be a valuable addition to the consumer packaging landscape and envision using the end product of Phase 2 with a variety of different molds to solve a number of excess plastic waste concerns, including for example, water/soda bottles, plastic egg cartons, plastic straws, etc. This technology may also be applied to any container and/or packaging, which is within the scope of this disclosure.

The present disclosure also comprises a novel apparatus 100 for biodegradable containers with seeds that can germinated, wherein the seeds are included in or enclosed in the material of the biodegradable container, or wherein the seeds are included in or enclosed in a biodegradable element of a container.

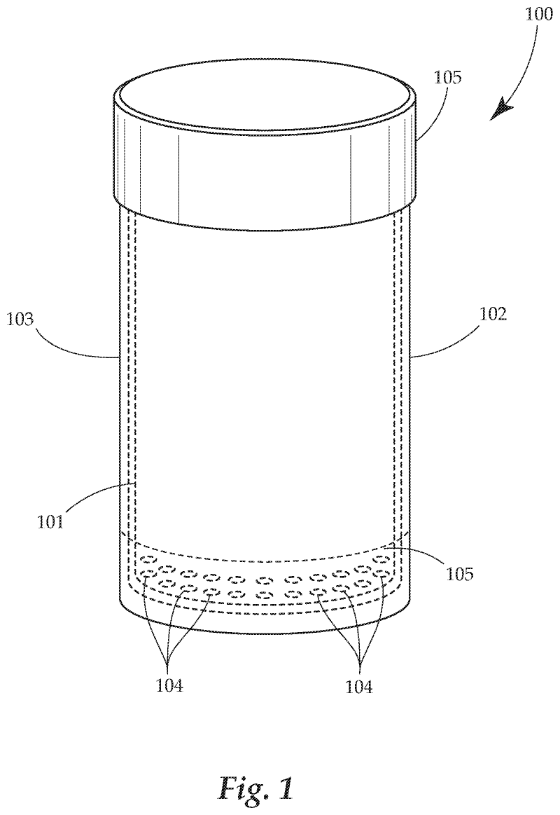

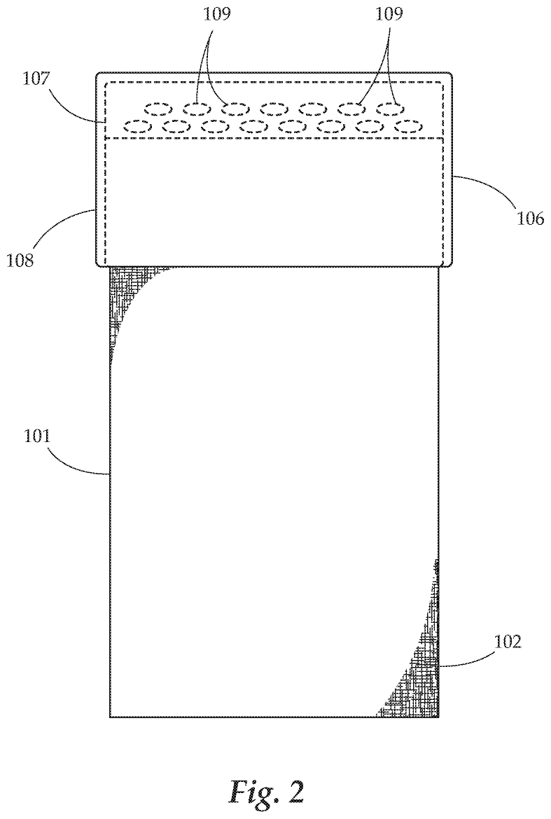

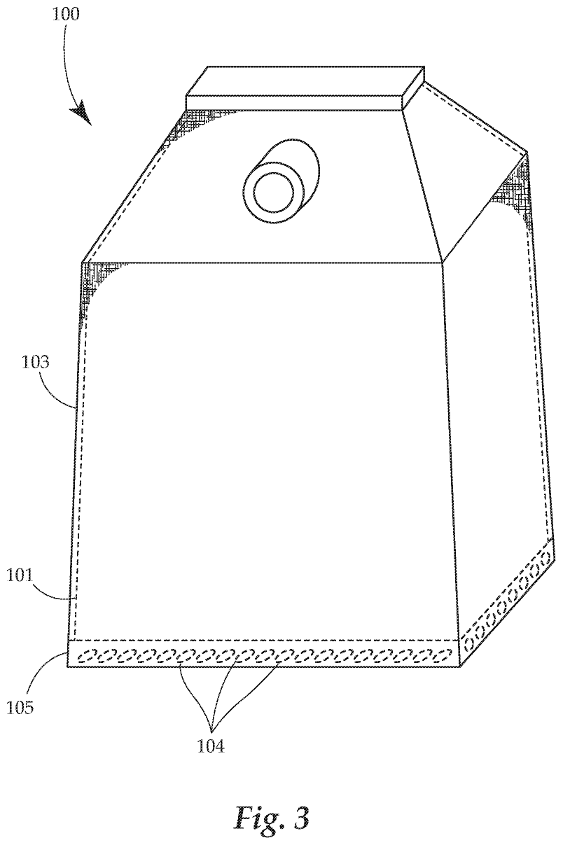

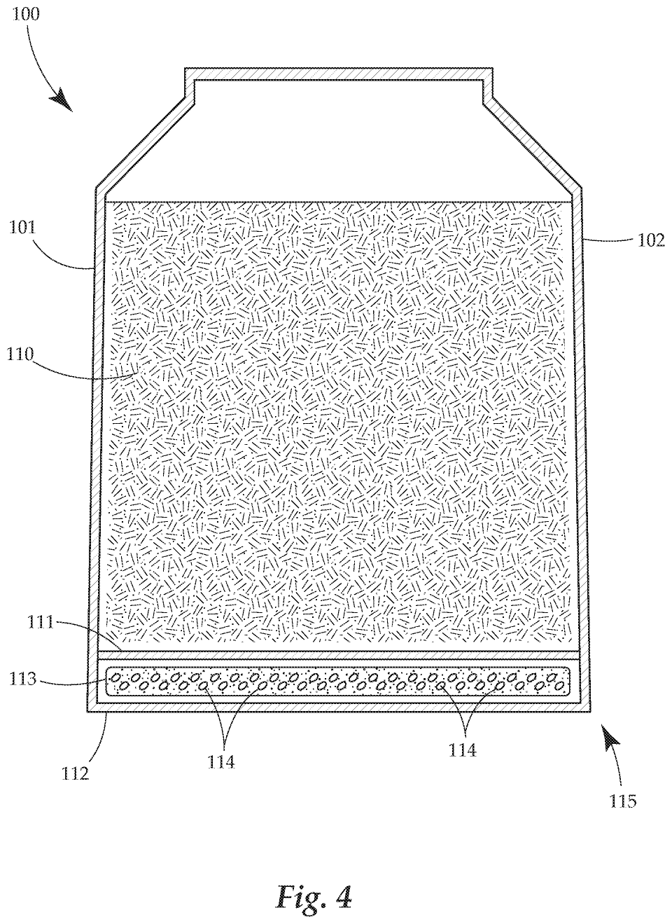

With reference to FIGS. 1, 2, 3, and 4, the apparatus 100 of the present invention may comprise a main container body 101 comprising at least one container material 102, a container protective layer 103, and a plurality of seeds 104 in a container compartment 105 disposed as part of the main container body 101.

The main container body 101 may be disposed as a water bottle, an egg carton, a pill bottle, an item of cutlery, a vacuum-pack or thin-film packaging including but not limited to those used with shelf-stable products such as potato chips or snack bars, a flexible plastic such as six-pack beverage rings, a cap or lid for a drink cup, or a milk carton. The main container body 101 may it has been found advantageous be disposed to suitably contain the primary container contents 110, which, it will be understood by one of skill in the art, will suggest or require any of several different forms or shapes of the main container body 101.

The container material 102 may be a biodegradable material such as a biodegradable plastic, a biodegradable starch-based or sugar-based material, a biodegradable cardboard or paperboard, or other biodegradable material now known or later invented. Similarly, the container protective layer 103 may be a biodegradable material such as a biodegradable plastic, a biodegradable starch-based or sugar-based material, a biodegradable cardboard or paperboard, or other biodegradable material now known or later invented, which it has been found advantageous is disposed in the main container body 101 to separate the primary container contents 110 from the plurality of seeds 104, where the plurality of seeds 104 is disposed in the main container body 101 and separated from the primary container contents 110 by the container protective layer 103.

In another aspect of the present invention, the apparatus 100 may comprise a main container body 101, a container element 107 comprising at least one element material 106, an element protective layer 108, and a plurality of seeds 109 in the container element 107.

The element material 106 may be a biodegradable material such as a biodegradable plastic, a biodegradable starch-based or sugar-based material, a biodegradable cardboard or paperboard, or other biodegradable material now known or later invented. Similarly, the element protective layer 108 may be a biodegradable material such as a biodegradable plastic, a biodegradable starch-based or sugar-based material, a biodegradable cardboard or paperboard, or other biodegradable material now known or later invented, which it has been found advantageous is disposed in the container element 107 to separate the primary container contents 110 from the plurality of seeds 109, where the plurality of seeds 109 is disposed in the container element 107 and separated from the primary container contents 110 by the element protective layer 108.

In another aspect of the present invention, the apparatus 100 may comprise a main container body 101 comprising at least one container material 102, which comprises a first layer 111 of container material 102, a second layer 112 of container material 102, and a plurality of seeds 114 between the first layer 111 of container material 102 and the second layer 112 of container material 102. In another aspect of the present invention, the main container body 101 may comprise at least a first layer 111 of a first container material 102 and at least a second layer 112 of a second container material 115, and a plurality of seeds 114 between the first layer 111 of container material 102 and the second layer 112 of second container material 115. The second container material 115 may have any of the properties of the container material 102 described herein. The first layer 111 and the second layer 112 may be in direct contact with the plurality of seeds 114, or the plurality of seeds 114 may be enclosed in a seed protective material 113 which is between the first layer 111 and the second layer 112. The seed protective material 113 may have any of the properties described herein for the container material 102, or may be a biodegradable material which is suitable for containing seeds and protecting and securing them in place during the manufacturing of the main container body 101 or container element 107, but which seed protective material 113 itself would not be sufficient to contain the primary container contents 110. For instance, without limiting the foregoing, the seed protective material 113 may be a biodegradable paper tape or plastic film, such that the seed protective material 113 containing the plurality of seeds 114 may be placed on or into either of the first layer 111 or the second layer 112 during manufacturing of the main container body 101 or of the container element 107.

A further advantage of the present invention is that can protect the plurality of seeds 104, the plurality of seeds 109, and/or the plurality of seeds 114 from both the primary container contents 110 and from impacts and moisture during manufacturing, transportation, and storage of the apparatus 100, so that the seeds can be planted and successfully germinate. The seeds used may be for any plant, including but not limited to flowers, trees, food crops, or crops used for erosion control or other purposes.

Certain embodiments of the present invention were described above. From the foregoing it will be seen that this invention is one well adapted to attain all the ends and objects set forth above, together with other advantages, which are obvious in and inherent to the inventive apparatus disclosed herein. It will be understood that certain features and sub-combinations are of utility and may be employed without reference to other features and sub-combinations. It is expressly noted that the present invention is not limited to those embodiments described above, but rather the intention is that additions and modifications to what was expressly described herein are also included within the scope of the invention. Moreover, it is to be understood that the features of the various embodiments described herein are not mutually exclusive and can exist in various combinations and permutations, even if such combinations or permutations were not made express herein, without departing from the spirit and scope of the invention. In fact, variations, modifications, and other implementations of what was described herein will occur to those of ordinary skill in the art without departing from the spirit and the scope of the invention. As such, the invention is not to be defined only by the preceding illustrative description.

Accordingly, what is claimed is:

1. A biodegradable container comprising:
a container body formed at least partially of a biodegradable material; and
one or more seeds that can be germinated within the biodegradable material.
